(19) United States
(12) Patent Application Publication
(10) Pub. No.: US 2026/0054322 A1
(43) Pub. Date: Feb. 26, 2026

(54) CONTROL METHOD FOR LASER CLADDING FORMING OF TITANIUM ALLOY LOAD-BEARING FRAME COMPONENTS

(71) Applicant: Shenyang Aircraft Corporation (SAC), Shenyang (CN)

(72) Inventors: Keming LI, Shenyang (CN); Yanmei LIU, Shenyang (CN); Jianchao ZHENG, Shenyang (CN); Jipeng SHI, Shenyang (CN); Feng GUAN, Shenyang (CN)

(21) Appl. No.: 19/371,875

(22) Filed: Oct. 28, 2025

Related U.S. Application Data
(63) Continuation of application No. PCT/CN2024/104697, filed on Jul. 10, 2024.

(30) Foreign Application Priority Data
Oct. 11, 2023 (CN) 202311307620.5

(51) Int. Cl. B23K 26/34

(52) U.S. Cl. CPC B23K 26/34

(57) ABSTRACT

The present invention belongs to the field of material processing and manufacturing, and provides a control method for laser cladding forming of titanium alloy load-bearing frame components. The control method designs a physical separation surface of each block subpiece, a fillet state of each technological interface, the margin size of each technology, the forming spatial positions of web plates and a heat treatment gear for the forming of the block subpieces, designs a connection groove form and a connection method among the block subpieces for the formed block subpieces, and conducts laser cladding connection for the block subpieces for connection forming. The present invention adopts first block forming and final connection, which effectively reduces the deformation of the components. The same technology is used for connection, which enhances the consistency with the metallurgical structural properties of a component matrix at the connection.

### CROSS REFERENCE TO RELATED APPLICATIONS

This application is a Continuation co-pending International Application No. PCT/CN2024/104697 filed on Jul. 10, 2024, which claims priority of application No. 202311307620.5 filed in China on Oct. 11, 2023, the entire contents of both of which are hereby incorporated by reference.

### TECHNICAL FIELD

The present invention relates to the field of material processing and manufacturing, and particularly relates to a control method for laser cladding forming of titanium alloy load-bearing frame components.

### BACKGROUND

With the increasing requirements of light weight and long service life for aircraft, large-scale integrated manufacturing technologies have eliminated assembly connection, decreased the number of parts and reduced the quality of components. Meanwhile, the technologies have reduced the physical separation surfaces for component manufacturing, improved the integrity of the components, improved the use performance of the components, and extended the service life of the components. In the laser cladding forming technology, with high energy laser as a heat source and metal alloy powder as a filling material, the laser and the alloy act synchronously on a metal surface to quickly melt to form a molten pool, and then quickly solidify to form a dense, thickness-controlled and uniform-structure metallurgical bonding layer. In the cladding process, high-purity argon is used for powder transportation and coaxial protection to prevent the molten pool from being oxidized in the forming process. As a forming technology for complex components, the laser cladding forming technology has the characteristics of good integrity of formed components, high structural consistency and good adaptability to the shapes of the components, and has been applied in the manufacturing of large aviation components. However, titanium alloy laser cladding forming is conducted in an argon-filled tank. It is difficult to adjust the adaptability in the forming process, and is easy to cause splashing and pollution to a gun head, thereby reducing the stability of the forming process and affecting the forming quality. The matrices of the titanium alloy laser cladding components are heated for many times, and have large and non-uniform thermal stress inside, which may lead to the problems of cladding layer cracking and matrix deformation. As the sizes of the components are gradually increased, the problems become more obvious. Therefore, in the forming process of large titanium alloy components, the process technologies, control measures and gear design for forming need to be designed reasonably, so as to reduce the occurrence of defects, realize the controllability of the production process of parts, and realize the qualified delivery and use of the formed components.

### SUMMARY

In view of the problems of instability and difficulty in deformation control in the laser cladding forming process of titanium alloy load-bearing frame components proposed above, the present invention provides a control method for laser cladding forming of titanium alloy load-bearing frame components, which adjusts and corrects the angle of a forming gun head in good time in an initial stage and process control to improve the pollution degree of splashing to the forming gun head, enhance the stability of the forming process and improve the quality of formed components. The rounding state of each technological interface is subjected to optimal design, the stress concentration degree in the forming process is improved and the risk of cracking in the forming process is reduced. The forming separation surface of the component is reasonably designed, block manufacturing is conducted, and finally laser cladding connection is conducted. The stress is dispersed to each block subpiece, and the stress is relieved by heat treatment in time, so as to alleviate the deformation state of component forming and improve the consistency of the forming accuracy and the metallurgical properties of the component. A special heat treatment gear with shape follow-up occlusion is used, so as to improve the dimensional accuracy of the component by full-profile control and shape correction. The connection groove form and the connection technology are reasonably designed, and connection deformation is controlled, to achieve quality improvement and deformation control of laser cladding forming.

The present invention has the following technical solution: A control method for laser cladding forming of titanium alloy load-bearing frame components designs a physical separation surface of each block subpiece, a fillet state of each technological interface, the margin size of each technology, the forming spatial positions of web plates and a heat treatment gear for the forming of the block subpieces, designs a connection groove form and a connection method among the block subpieces for the formed block subpieces, and conducts laser cladding connection for the block subpieces for connection forming;

The forming of the block subpieces comprises the following steps:
step 1.1: conducting laser cladding forming according to the requirements of web plates of the block subpieces S₁, S₂, S₃ and the like to form corresponding web plates B₁, B₂, B₃, and the like; and conducting stress relief annealing for the web plates in the process of laser cladding forming;
step 1.2: fixing the web plates on the heat treatment gear G₁, and conducting laser cladding forming for stiffeners A₁ at one side based on the web plates;
step 1.3: conducting stress relief annealing for the stiffeners A₁ and the heat treatment gear G₁;
step 1.4: installing the heat treatment gear G₂ at one side of the web plates in which the stiffeners A₁ are formed, removing the heat treatment gear G₁ and conducting laser cladding forming for stiffeners A₂ on the other side of the web plates;
step 1.5: conducting stress relief annealing for the stiffeners A₂ and the heat treatment gear G₂;
step 1.6: removing the heat treatment gear G₂, and conducting rough machining for the formed blank subpieces to eliminate margins;
The connection forming method comprises the following steps:
step 2.1: designing and processing the block subpieces as pieces to be connected according to the groove form, and installing on a connecting gear;
step 2.2: connecting the block subpieces by laser cladding forming based on the designed connection method to obtain a whole component;
step 2.3: conducting double annealing for the whole component, and conducting overall processing and net forming.

The surfaces of the heat treatment gear G₁ and the heat treatment gear G₂ correspond to the upper surfaces and the lower surfaces of the web plates respectively; and bulges and sags are arranged on the heat treatment gear G₁ and the heat treatment gear G₂, and are occluded with the web plates.

The connecting gear comprises a lug boss, a fixing support, adjusting bolts and normal adjusting bolts; the lug boss is fixed to the bottom of one end of the fixing support, and a fixing bolt is fixed to the top of one end; two adjusting bolts and two normal adjusting bolts are installed on the other end of the fixing support respectively; axial directions between the adjusting bolts and the normal adjusting bolts are opposite; the fixing bolt is abutted against a block subpiece to ensure that there is no gap and no tilt between the block subpiece and the fixing support; the two adjusting bolts are adjusted to ensure that there is no order difference between the inner side of the block subpiece and the chamfer position of the other block subpiece; and the two normal adjusting bolts are adjusted to ensure that there is no order difference between the outer side of the other block subpiece and the chamfer position of the block subpiece.

After the determining rules of the physical separation surface of the block subpieces are conducted successively as follows, the block subpieces are marked successively as S₁, S₂, S₃, and the like:
rule 1: an original component is divided along the longest direction of the original component, and the sizes of the block subpieces after dividing are not greater than 1000 mm along the longest direction of the original component;
rule 2: the section size of the physical separation surface is a part with the smallest section size of all physical separation surfaces to be selected;
rule 3: equal division;
if rule 3 cannot be satisfied together with rule 1 and rule 2, only rule 1 and rule 2 are satisfied.

The fillet state of each technological interface adopts rounding processing; the rounding is designed for each technological interface and a neck shrinking position and a neck expanding position along the growth direction; a chamfer with a rounding radius of not less than 20 mm is arranged at each technological interface, and a chamfer with a rounding radius of not less than 10 mm is arranged at the neck shrinking position and the neck expanding position.

The margin size of the technology is determined as follows:
When each block subpiece is formed, the margin of web plate thickness H₁ is not less than 10 times of a theoretical thickness h₁, and a relationship between the height margin H₂ of the stiffener and a theoretical height h₂ of the stiffener is calculated according to formula (1); a distance from a web plate margin H₃ to the outer edge contour of the stiffener is not less than 75 mm;

$${H}_{2} \geq {h}_{2} ( 1 + 1 / 6 ) . \qquad ( 1 )$$

An arrangement principle of the forming spatial positions of the web plates is: firstly, an angle between the growth direction of the web plate and a part forming lower surface is not greater than 30 degrees, and secondly, the minimum section of the web plate is selected as a bottom surface; and the bottom surface is fitted to a substrate.
the groove form and the connection method are specifically: grooves of a connection region are asymmetric X-type grooves, and comprise shallow grooves and deep grooves with different depths, wherein the depth of the shallow grooves and the depth of the deep grooves is 1:2; the docking positions of the block subpieces have chamfers with a radius of 2 mm;
The deep grooves are filled with alloy powder by laser cladding forming; when the alloy powder is filled to ½ thickness of the deep grooves, the connecting gear is turned to continue the laser cladding forming; the shallow grooves are filled with alloy material until the alloy material is flush with the web plates, and the connecting gear is turned to fill the deep grooves until the alloy material is flush with the web plates; the stiffener parts of the deep grooves are filled to be flush with the upper surfaces of the stiffeners; and the connecting gear of the block subpieces is turned to fill the stiffener parts of the shallow grooves to be flush with the upper surfaces of the stiffeners.

The laser cladding forming comprises spatial attitude adjustment of laser gun heads, interlayer temperature control and forming shape defect compensation control; the spatial attitude adjustment of laser gun heads is that working heights of the laser gun heads satisfy the requirements of the forming technology while the axis and a vertical direction have an inclination of 3°-8°; the interlayer temperature control is that cladding forming is continued at the same part along the growth direction when the temperature of a previous layer is not greater than 200° C.; the forming shape defect compensation is that in the process of cladding forming, when a formed part collapses and is visually less than the height of other parts by more than 10 mm, the collapse part is compensated by single-region laser cladding until a height difference is visually not greater than 5 mm.

The compensation frequency of the single-region laser cladding compensation is not greater than 3 times; if a height compensation effect is not reached at specified times, then the compensation is not conducted; and after subsequent 2 times of full-profile laser cladding forming, the collapse part is compensated to a required height.

The present invention has the following beneficial effects:
(1) The stress accumulation of the integrated manufacturing of large-size components is distributed to the manufacturing of each subpiece by the technology of first block forming and final connection, which effectively reduces the deformation of the components. At the same time, the same technology is used for connection, which enhances the consistency with the metallurgical structural properties of the component matrix at the connection.
(2) The occlusal manufacture gear is adopted, which increases the contact area between the gear and the component and enhances the manufacturing accuracy of the component size.
(3) The stability and the consistency of the forming process are effectively improved through the measures of gun head angle adjustment, interlayer temperature control and forming shape defect compensation, thereby achieving the overall improvement of the quality of the component.

### DESCRIPTION OF DRAWINGS

FIG. 1 is a schematic diagram of a load-bearing frame component;

FIG. 2 is a schematic diagram of web plate manufacturing;

FIG. 3 is a schematic diagram of web plate fixing;

FIG. 4 is a schematic diagram of an occlusal gear;

FIG. 5 is a schematic diagram of a groove;

FIG. 6 is a structural diagram of connection and clamping.

In the figures: 1 separation surface a; 2 separation surface b; 3 left component segment; 4 right component segment; 5 middle component segment; 6 web plate; 7 chamfer a; 8 chamfer b; 9 fixing hole; 10 occlusal gear; 11 component; 12 shallow side height; 13 deep side height; 14 connecting gear; 15 lug boss; 16 fixing bolt; 17 fixing support; 18 adjusting bolt a; 19 adjusting bolt b; 20 normal adjusting bolt a; 21 normal adjusting bolt b.

### DETAILED DESCRIPTION

The present invention will be further described in detail below in combination with the drawings, so that those skilled in the art can implement the present invention according to the words of the description.

A control method for laser cladding forming of titanium alloy load-bearing frame components adopts a technology of block manufacturing and final laser cladding connection, reasonably designs a physical separation surface of each block subpiece, a fillet state of each technological interface, the margin size of each technology, the forming spatial positions of web plates and a heat treatment gear form, optimizes a connection groove form and a connection method, improves the deformation state of formed components, conducts laser cladding connection for the block subpieces for connection forming by a connecting gear; improves the stability of the cladding process by timely adjustment of the angle of the laser forming gun heads and timely repairing of bad forming surfaces, and enhances the forming quality.

The load-bearing frame component to be manufactured is divided into block subpieces along the physical separation surface, and each technological surface of each block subpiece is subjected to rounding, technological margin determining and arrangement position planning of laser cladding forming of the web plates of each block subpiece. Each block subpiece is manufactured by the laser cladding forming technology and the supporting technology according to the procedures of the design technology, and the final connection and manufacturing of the component are completed by the laser cladding connection technology and the supporting technology according to the procedures of the design technology.

Further, the component is divided into equal parts by the physical separation surface of the block subpiece along the longest direction of the original component, which can avoid long-time and repeated heating of the component matrix when the large-size component is formed integrally, avoid producing large and uneven thermal stress and avoid serious deformation or cracking of the component. The size of the optimized divided block subpiece is not greater than 1000 mm along the length direction of the original component, and the parts with smaller component size are preferred as dividing parts. When the equal dividing cannot satisfy the requirement of preferring the parts with smaller component sizes, the preferred parts with smaller component sizes are taken as the priority to mark the block subpieces successively as S₁, S₂, S₃ and the like.

Further, the rounding processing of the technological interfaces is to further optimize the stress concentration state of the forming process and avoid the cracking caused by the stress concentration in the forming process on the basis of the block manufacturing. The rounding is designed for each technological interface and a neck shrinking position and a neck expanding position along the growth direction, wherein a chamfer with a rounding radius of not less than 20 mm is arranged at each technological interface, and a chamfer with a rounding radius of not less than 10 mm is arranged at the neck shrinking position and the neck expanding position.

Further, the technological margin determining is to compensate for the deformation caused by multiple heating during the laser melting forming of the block subpieces, and to remove the margin during the subsequent surface processing of the component. When each block subpiece is formed, the margin of web plate thickness H₁ is not less than 10 times of a theoretical thickness h₁, and a relationship between the height margin H₂ of the stiffener and a theoretical height h₂ of the stiffener is calculated according to formula (1). Web plate manufacturing needs to consider the clamping margin of the web plates when the subsequent webs are used for making stiffeners for the substrate. A distance from a web plate margin H₃ to the outer edge contour of the stiffener is not less than 75 mm. If the web plate margin is too large, the overall stiffness of the plate is reduced, which will easily cause the bulge on the plate surface during the subsequent stiffener manufacturing and affect the product quality. If the web plate margin is too small, the clamped amount is insufficient during the subsequent stiffener manufacturing, and the forming process is unstable.

$${H}_{2} \geq {h}_{2} ( 1 + 1 / 6 ) . \qquad ( 1 )$$

Further, an arrangement principle of the forming spatial positions of the web plates is: firstly, an angle between the growth direction of the web plate and a part forming lower surface is not greater than 30 degrees, and secondly, the minimum section of the web plate is selected as a bottom surface; and the bottom surface is fitted to a substrate.

Further, the heat treatment gear adopts the occluding design of the gear and the component, and makes an integrated bulge consistent with the sag of the load-bearing frame component on a plate. The size of the bulge is reduced by 10 mm in equal proportion to the sag size of the component. When the bulge is occluded with the formed component, the full profile of the occluding gear can be fitted with the component to improve the consistency of the heat treatment profile.

Further, the connecting gear is designed with lightweight double-sided symmetrical frame structure. Clamping points are arranged on both sides of the connecting part and are locked by bolts. The positions of the clamping points should satisfy the requirement of reducing the distance between the clamping points and the groove to be filled on the basis that each part of the connecting clamping gear does not interfere with the laser cladding gun head during the connection forming.

Further, the use method of the connecting gear is that: the block subpieces are positioned firstly according to the position of the lug boss, and then the groove position is adjusted, including: abutting against the segment piece by the fixing bolt to ensure that there is no gap and no tilt between the segment piece and the fixing support, adjusting the normal adjusting bolt at the inner side to ensure that there is no order difference between the inner side of the segment piece and the chamfer position of the segment piece, and adjusting the normal adjusting bolt at the outer side to ensure that there is no order difference between the outer side of the segment piece and the chamfer position of the segment piece.

The laser cladding forming technology comprises spatial attitude adjustment of laser gun heads, interlayer temperature control and forming shape defect compensation.

Further, the spatial adjustment of laser gun heads is that working heights of the gun heads satisfy the requirements of the forming technology while the axis and a vertical direction have an inclination of 3°-8°, to prevent the spatter generated in the forming process from spraying upward and polluting the laser gun heads.

Further, the interlayer temperature control is that the temperature of a bottom layer is not greater than 200° C. when the cladding of the previous layer is allowed at the same part along the growth direction.

Further, the forming shape defect compensation is to observe the forming shape through a viewing window on a forming chamber in the forming process. It is found that when a formed part collapses and is visually less than the height of other parts obviously by more than 10 mm, the collapse part needs to be compensated in time by single-region laser cladding until a height difference is visually not greater than 5 mm. Preferably, the compensation frequency of a single region is not greater than 3 times; if a height compensation effect is not reached at specified times, then the compensation is not conducted; and after subsequent 2 times of full-profile laser cladding forming, the collapse part is compensated to a required height.

Grooves of a connection region are asymmetric X-type grooves, and comprise an upper part and a lower part with different depths, wherein the depth of the shallow grooves is ⅓ of part thickness, and the depth of the deep grooves is ⅔ of part thickness. The chamfer at the docking position is a chamfer with a radius of 2 mm. To prevent the order difference, the connecting gear is used for fixation during connection.

The connection method uses the laser cladding forming to fill the deep side firstly. When filling to ½ thickness of the deep side, the connecting gear is turned to fill the shallow side to be flush with the web plates; the connecting gear is turned to fill the deep side to be flush with the web plates and fill the stiffener position to be flush with the upper surface of the stiffener; and the connecting gear is turned to fill the shallow stiffener position to be flush with the upper surface of the stiffener.

The forming method of each block subpieces comprises:
step 1.1: conducting laser cladding forming according to the requirements of web plates of the block subpieces S₁, S₂, S₃ and the like to form corresponding web plates B₁, B₂, B₃, and the like; and conducting stress relief annealing for the web plates in the process of laser cladding forming;
step 1.2: fixing the web plates on the heat treatment gear G₁, and conducting laser cladding forming for stiffeners A₁ at one side based on the web plates;
step 1.3: conducting stress relief annealing for the stiffeners A₁ and the heat treatment gear G₁;
step 1.4: installing the heat treatment gear G₂ at one side of the web plates in which the stiffeners A₁ are formed, removing the heat treatment gear G₁ and conducting laser cladding forming for stiffeners A₂ on the other side of the web plates;
step 1.5: conducting stress relief annealing for the stiffeners A₂ and the heat treatment gear G₂;
step 1.6: removing the heat treatment gear G₂, and conducting rough machining for the formed blank subpieces to eliminate margins;
The connection forming method comprises the following steps:
step 2.1: designing and processing the block subpieces as pieces to be connected according to the groove form, and installing on a connecting gear;
step 2.2: connecting the block subpieces by laser cladding forming based on the designed connection method to obtain a whole component;
step 2.3: conducting double annealing for the whole component, and conducting overall processing and net forming.

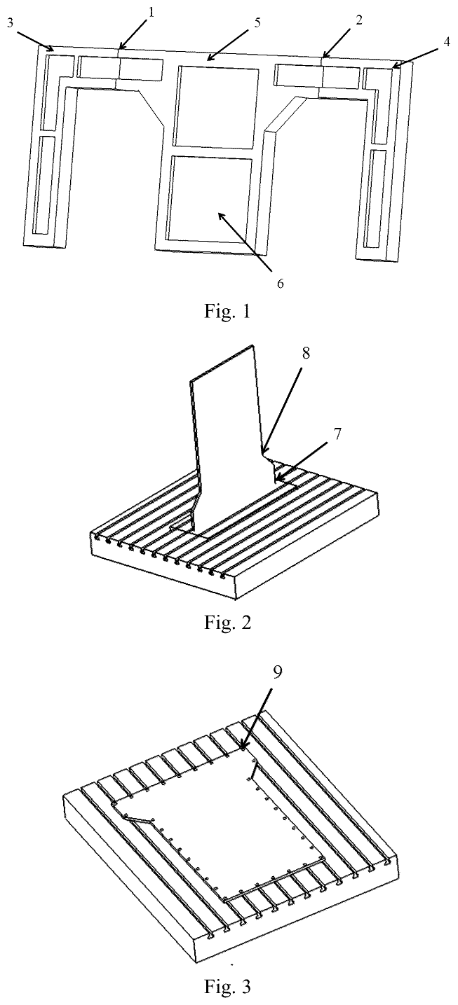

A specific embodiment, such as the load-bearing frame component shown in FIG. 1, is taken as an example below to conduct the operation of the technical solution.

Step 1: according to the sizes of the embodiment, the parts are divided into three segments by using a separation surface al and a separation surface b2, i.e., a left component segment 3, a right component segment 4, and a middle component segment 5. The outline size of each segment is 1000 mm×1200 mm×60 mm. Other features are retained. According to the projection plane of the parts in the thickness direction, the theoretical web plate size is 1000 mm×1200 mm×2 mm. The margin of 100 mm is increased at one side in the length direction. The margin of 150 mm is increased at one side in the width direction. The margin of 11 mm is increased at one side in the thickness of the web plate 6. The actual size of the formed web plate is 1200 mm×1500 mm×24 mm, and the margin of the vertical rib at one side is 5 mm.

Step 2: processing and manufacturing of the middle segment: the web plates are vertically placed with 1200 mm×20 mm plane as the contact surface, R20 chamfer a7 is set between the web plates and the substrate, and R10 chamfer b8 is set at the neck shrinking position to prevent the cracking problem caused by stress concentration, as shown in FIG. 2. The spatial attitude of laser gun heads is adjusted so that a slope angle is 5°. According to the forming technological parameters, the web plates are printed. With the heights of the web plates, stress relief annealing heat treatment should be conducted when the heights are 100 mm, 700 mm and 1500 mm. The time interval between the printing process and the heat treatment technology should not be greater than 12 hours. The heat treatment parameters are 650° C., heat preservation for 2 hours, and air cooling. Because the actual formed parts have the margins which shall be removed subsequently by machining, an air furnace can be selected as a heat treatment furnace.

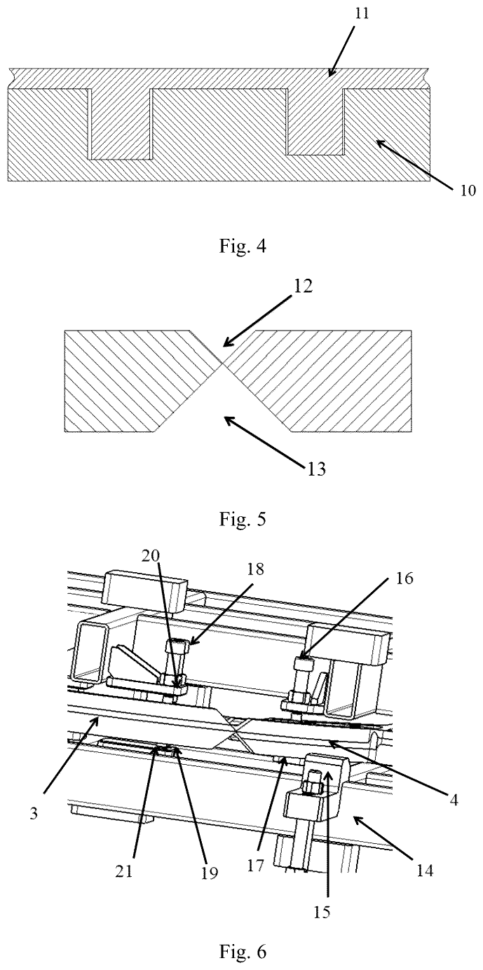

Step 3: the web plates after heat treatment are milled and drilled with a fixing hole 9, as shown in FIG. 3. The aperture is M20 to ensure the deformation controllability in the printing process of the vertical rib. After machining, the thickness of the web plates is 20 mm. After milling, the surfaces of the web plates should be mechanically polished to increase the surface roughness to be not less than Ra6.3 to ensure better adhesion between the first printing layer and the web plates. After the front vertical rib is printed, stress relief heat treatment should be conducted. After cooling, the vertical rib is turned over and installed on an occlusal gear 10. The surface of the component 11 is fitted with the upper surface of the gear, and is clamped and fixed by the bolts. The printing of the back vertical rib and stress relief annealing are continued, as shown in FIG. 4.

Step 4: steps 2 and 3 are repeated in sequence to complete the printing of the left component segment 3 and the right component segment 4.

Step 5: groove design and processing. According to the total thickness of the parts (about 88 mm, with web plate thickness of 20 mm, and single-side height of vertical rib of 29+5), a shallow side height 12H₁ and a deep side main height 13H₂ are calculated respectively, as shown in FIG. 5. The calculation process is as follows:

$${H}_{1} = 1 / 3 \times ( 88 - 2 ) \approx 29 mm \\ {H}_{2} = 2 / 3 \times ( 88 - 2 ) \approx 57 mm$$

A groove opening angle is selected as 90°. The opening angle can be adjusted between 90° and 100° according to the size of the cladding head to ensure that the cladding head is accessible under the specified defocusing amount, and the groove milling can be completed according to the size. In addition, when the margins of the web plates are removed, a positioning lug boss for the connecting gear needs to be reserved. After machining, X-ray inspection and ultrasonic test should be conducted for each segment piece to ensure that there is no metallurgical defect inside the parts. If there are metallurgical defects, the defective parts should be removed mechanically and then reprinted.

Step 6: the processed segment piece is fixed on the connecting gear 14, as shown in FIG. 6. Firstly, each segment of the component is positioned according to the position of the lug boss 15, and the groove position is adjusted. Specific steps are as follows: \textcircled{1} the fixing bolt 16 is abutted against a block subpiece to ensure that there is no gap and no tilt between the block subpiece and the fixing support 17; \textcircled{2} the adjusting bolt a18 at the inner side and the adjusting bolt b19 are adjusted to ensure that there is no order difference between the inner side of the adjacent block subpiece and the chamfer position of the block subpiece; \textcircled{3} the normal adjusting bolt a20 at the outer side and the normal adjusting bolt b21 are adjusted to ensure that there is no order difference between the outer side of the block subpiece and the chamfer position of another adjacent block subpiece.

Step 7: laser welding is used for backing. Welding power is 3500 W, welding speed is 1200 mm/min, defocusing amount is +20 mm. The back surface of a weld is mechanically polished after welding. After X-ray inspection, if there is no gas hole or crack, then powder feeding connection is conducted.

Step 8: firstly, the deep side is filled. The filling height is ½. After complete cooling, the deep side is turned over to fill the shallow region to a filling height flush with the web plate. After cooling, the deep side is turned over again, and the remaining ½ of the deep region is filled to finally complete the overall connection. The method can effectively avoid the problem of large overall deformation of the part caused by too large one-sided filling amount, and the two sides are alternately filled, which can offset part of the deformation so that the overall deformation of the part is controllable. After the connection is complete, X-ray inspection is conducted for the position of the connection region to ensure that there is no metallurgical defect in the region.

Step 9: double annealing heat treatment is conducted for the whole part in the clamping state of the gear.

Step 10: three-dimensional scanning is conducted for the whole part to determine the rough machining digifax of the part, and machining and net forming are conducted according to the digifax to finally complete the delivery of the part.

1. A control method for laser cladding forming of titanium alloy load-bearing frame components, designing a physical separation surface of each block subpiece, a fillet state of each technological interface, the margin size of each technology, the forming spatial positions of web plates and a heat treatment gear for the forming of the block subpieces, designing a connection groove form and a connection method among the block subpieces for the formed block subpieces, and conducting laser cladding connection for the block subpieces for connection forming;
wherein the forming of the block subpieces comprises the following steps:
step 1.1: conducting laser cladding forming according to the requirements of web plates of the block subpieces S₁, S₂, S₃ and the like to form corresponding web plates B₁, B₂, B₃, and the like; and conducting stress relief annealing for the web plates in the process of laser cladding forming;
step 1.2: fixing the web plates on the heat treatment gear G₁, and conducting laser cladding forming for stiffeners A₁ at one side based on the web plates;
step 1.3: conducting stress relief annealing for the stiffeners A₁ and the heat treatment gear G₁;
step 1.4: installing the heat treatment gear G₂ at one side of the web plates in which the stiffeners A₁ are formed, removing the heat treatment gear G₁ and conducting laser cladding forming for stiffeners A₂ on the other side of the web plates;
step 1.5: conducting stress relief annealing for the stiffeners A₂ and the heat treatment gear G₂ step 1.6: removing the heat treatment gear G₂, and conducting rough machining for the formed blank subpieces to eliminate margins;
the connection forming comprises the following steps:
step 2.1: designing and processing the block subpieces as pieces to be connected according to the groove form, and installing on a connecting gear;
step 2.2: connecting the block subpieces by laser cladding forming based on the designed connection method to obtain a whole component;
step 2.3: conducting double annealing for the whole component, and conducting overall processing and net forming;
bulges and sags are arranged on the heat treatment gear G₁ and the heat treatment gear G₂, and are occluded with the web plates;
the connecting gear comprises a lug boss (15), a fixing support (17), adjusting bolts and normal adjusting bolts; the lug boss (15) is fixed to the bottom of one end of the fixing support (17), and a fixing bolt (16) is fixed to the top of one end; two adjusting bolts and two normal adjusting bolts are installed on the other end of the fixing support (17) respectively; axial directions between the adjusting bolts and the normal adjusting bolts are opposite; the fixing bolt (16) is abutted against a block subpiece to ensure that there is no gap and no tilt between the block subpiece and the fixing support (17); the two adjusting bolts are adjusted to ensure that there is no order difference between the inner side of the block subpiece and the chamfer position of the other block subpiece; and the two normal adjusting bolts are adjusted to ensure that there is no order difference between the outer side of the other block subpiece and the chamfer position of the block subpiece;
after the determining rules of the physical separation surface of the block subpieces are conducted successively as follows, the block subpieces are marked successively as S₁, S₂, S₃, and the like:
rule 1: an original component is divided along the longest direction of the original component, and the sizes of the block subpieces after dividing are not greater than 1000 mm along the longest direction of the original component;
rule 2: the section size of the physical separation surface is a part with the smallest section size of all physical separation surfaces to be selected;
rule 3: equal division;
if rule 3 cannot be satisfied together with rule 1 and rule 2, only rule 1 and rule 2 are satisfied;
the fillet state of each technological interface adopts rounding processing; the rounding is designed for each technological interface and a neck shrinking position and a neck expanding position along the growth direction; a chamfer with a rounding radius of not less than 20 mm is arranged at each technological interface, and a chamfer with a rounding radius of not less than 10 mm is arranged at the neck shrinking position and the neck expanding position;
the margin size of the technology is determined as follows:
when each block subpiece is formed, the margin of web plate thickness H₁ is not less than 10 times of a theoretical thickness h₁, and a relationship between the height margin H₂ of the stiffener and a theoretical height h₂ of the stiffener is calculated according to formula (1); a distance from a web plate margin H₃ to the outer edge contour of the stiffener is not less than 75 mm;
$${H}_{2} \geq {h}_{2} ( 1 + 1 / 6 ) ; \qquad ( 1 )$$
an arrangement principle of the forming spatial positions of the web plates is: firstly, an angle between the growth direction of the web plate and a part forming lower surface is not greater than 30 degrees, and secondly, the minimum section of the web plate is selected as a bottom surface; and the bottom surface is fitted to a substrate;
the groove form and the connection method are specifically: grooves of a connection region are asymmetric X-type grooves, and comprise shallow grooves and deep grooves with different depths, wherein the depth of the shallow grooves and the depth of the deep grooves is 1:2; the docking positions of the block subpieces have chamfers with a radius of 2 mm;
the deep grooves are filled with alloy powder by laser cladding forming; when the alloy powder is filled to ½ thickness of the deep grooves, the connecting gear is turned to continue the laser cladding forming; the shallow grooves are filled with alloy material until the alloy material is flush with the web plates, and the connecting gear is turned to fill the deep grooves until the alloy material is flush with the web plates; the stiffener parts of the deep grooves are filled to be flush with the upper surfaces of the stiffeners; and the connecting gear of the block subpieces is turned to fill the stiffener parts of the shallow grooves to be flush with the upper surfaces of the stiffeners;
the laser cladding forming comprises spatial attitude adjustment of laser gun heads, interlayer temperature control and forming shape defect compensation control; the spatial attitude adjustment of laser gun heads is that working heights of the laser gun heads satisfy the requirements of the forming technology while the axis and a vertical direction have an inclination of 3°-8°; the interlayer temperature control is that cladding forming is continued at the same part along the growth direction when the temperature of a previous layer is not greater than 200° C.; the forming shape defect compensation is that in the process of cladding forming, when a formed part collapses and is visually less than the height of other parts by more than 10 mm, the collapse part is compensated by single-region laser cladding until a height difference is visually not greater than 5 mm.

2. The control method for laser cladding forming of titanium alloy load-bearing frame components according to claim 1, wherein the surfaces of the heat treatment gear G₁ and the heat treatment gear G₂ correspond to the upper surfaces and the lower surfaces of the web plates respectively.

3. The control method for laser cladding forming of titanium alloy load-bearing frame components according to claim 1, wherein the compensation frequency of the single-region laser cladding compensation is not greater than 3 times; if a height compensation effect is not reached at specified times, then the compensation is not conducted; and after subsequent 2 times of full-profile laser cladding forming, the collapse part is compensated to a required height.
